(19) United States
(12) Patent Application Publication
(10) Pub. No.: US 2026/0131569 A1
(43) Pub. Date: May 14, 2026

(54) CONTROL MARK GENERATION MECHANISM

(71) Applicants: Walter F. Kailey, Frederick, CO (US); Akihiro Shima, Tokyo (JP); Tetsuya Mutoh, Tokyo (JP); Samuel Hopper, Boulder, CO (US); Scott R. Johnson, Boulder, CO (US)

(72) Inventors: Walter F. Kailey, Frederick, CO (US); Akihiro Shima, Tokyo (JP); Tetsuya Mutoh, Tokyo (JP); Samuel Hopper, Boulder, CO (US); Scott R. Johnson, Boulder, CO (US)

(73) Assignee: Ricoh Company, Ltd., Tokyo (JP)

(21) Appl. No.: 18/946,006

(22) Filed: Nov. 13, 2024

(51) Int. Cl. B41J 2/07; B41J 2/21; G06K 15/02

(52) U.S. Cl. CPC B41J 2/07; B41J 2/21; G06K 15/1809

(57) ABSTRACT

A printing system is disclosed. The printing system includes at least one physical memory device to store control mark logic and one or more processors coupled with at least one physical memory device to execute the control mark logic to generate control mark print instructions to direct a print engine to print a control mark on a print medium, wherein the control mark comprises a matrix of print regions extending in process and cross-process directions having a plurality of ink colors and insert printed control marks into instructed sheets of a print job based on the control mark print instructions.

### FIELD OF THE INVENTION

The invention relates to the field of image reproduction, and in particular, to production printing.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and two tandem print engines for duplex printing that include one or more printhead assemblies, where each assembly includes a printhead controller and a printhead (or array of printheads). Each printhead includes many nozzles (e.g., inkjet nozzles) for the ejection of ink or any colorant suitable for printing on a medium.

### SUMMARY

In one embodiment, a printing system is disclosed. The printing system includes at least one physical memory device to store control mark logic and one or more processors coupled with at least one physical memory device to execute the control mark logic to generate control mark print instructions to direct a print engine to print a control mark on a print medium, wherein the control mark comprises a matrix of print regions extending in process and cross-process directions having a plurality of ink colors and insert printed control marks into instructed sheets of a print job based on the control mark print instructions.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2A-2B are block diagrams of embodiments of a print controller;

FIG. 3 illustrates a control mark and flushline configuration;

FIG. 4 illustrates one embodiment of control mark logic;

FIGS. 5A-5C illustrate embodiments of a control mark and flushline configuration;

FIGS. 6A & 6B is a flow diagram illustrating one embodiment of a process for generating control mark print instructions;

FIG. 7 illustrates one embodiment of control mark logic implemented in a network; and

FIG. 8 illustrates one embodiment of a computer system.

### DETAILED DESCRIPTION

Control marks (e.g., alignment or cue marks) are implemented at pre-defined process direction locations (e.g., top or bottom portions) of a first sheet side (or A side) of a print medium during printing at a production printer to trigger printing of a second sheet side (or B side) at a precise time to align the B side printing with the A side printing of the sheet for duplex printing (e.g., printing on front and back sides of the print medium). Thus, printed control marks are typically identified by an optical sensor (e.g., a control mark sensor) located in a second print engine, which enables the second print engine to set the alignment of the printing on the B side according to the location of the control mark position in the process direction to align printing on the B side with printing on the A side. When the printed control mark passes the control mark sensor, the control mark sensor detects the printed control mark location on the print medium by detecting changes in optical density due to the printed control mark versus paper with no printing. In addition or alternatively, print control marks may be used to signal control to downstream processing equipment such as cutters, booklet makers, camera systems, etc.

Flushing patterns are also implemented in printing applications to prevent clogging of printhead nozzles due to inactivity by causing each nozzle to eject ink drops at a rate that avoids clogging. A flushline pattern comprises flushline markings (or flushlines) on the print medium that performs flushing for all printing nozzles for all ink colors implemented in the printer. Typically, a flushline pattern is a repeating print pattern of flushlines placed on each page/sheet that is in addition to the original print job data (e.g., text or images) on each sheet. Typically, flushline patterns are placed at the top or bottom portions of sheets so as to not interfere with the print job data. The printed flushline patterns may even be later removed from the sheets by cutting in post-processing operations.

A control mark may be placed over a flushline pattern in applications with flushline patterns on the same sheet side since displacing flushline patterns to make space for the control mark (or vice vera) results in the consumption of additional lengths of paper to make room for the displacements. Moreover, a single control mark overlapping (e.g., printed on top of) printed flushline patterns may pose problems for ink drying since an increased ink density may result in the overlap region. Further, control marks that prevent the flushlines from printing result in failure to flush all nozzles of all the colors of ink within the control mark area.

According to one embodiment, a mechanism is provided to generate control marks that facilitate line flushing. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

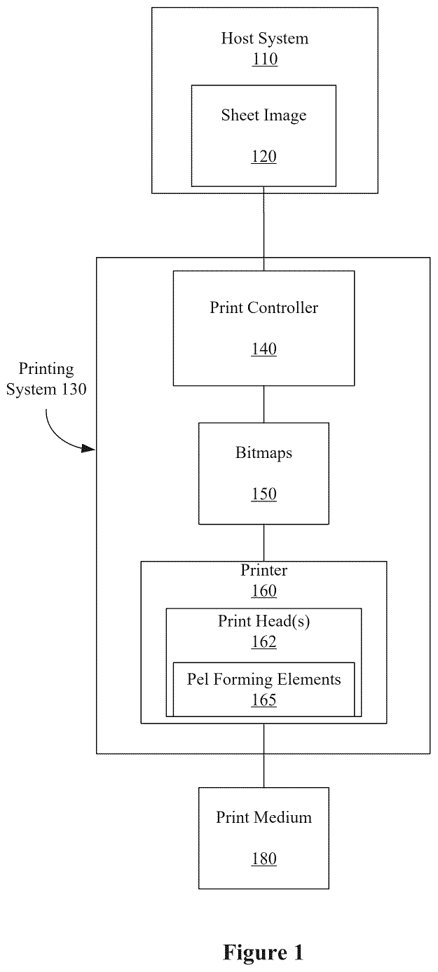

FIG. 1 is a block diagram illustrating one embodiment of a printing system 130. A host system 110 is in communication with the printing system 130 to print a sheet image 120 onto a print medium 180 via a printer 160 (e.g., one or more print engines). Print medium 180 may include paper, card stock, paper board, corrugated fiberboard, film, plastic, synthetic, textile, glass, composite or any other tangible medium suitable for printing. The format of print medium 180 may be continuous form or cut sheet or any other format suitable for printing. Printer 160 may be an ink jet or another suitable printer type.

In one embodiment, printer 160 comprises one or more printheads 162, each including one or more pel forming elements 165 that directly or indirectly (e.g., by transfer of marking material through an intermediary) forms the representation of picture elements (pels) on the print medium 180 with marking material applied to the print medium. In an ink jet printer, the pel forming element 165 (e.g., an ink jet nozzle) is a tangible device that ejects the ink (e.g., ink drops) onto the print medium 180. Typically, an ink jet nozzle ejects ink based on an actuator energized by an applied waveform. The waveforms for printing print data versus flushing (e.g., printing flush lines, as will be explained below) are typically different due to optimizations for those different functions. The pel forming elements may be grouped onto one or more printheads 162.

The pel forming elements 165 may be stationary (e.g., as part of a stationary printhead 162) or moving (e.g., as part of a printhead 162 that moves across the print medium 180) as a matter of design choice. Further, the pel forming elements 165 may be assigned to one of one or more color planes that correspond to types of marking materials (e.g., Cyan, Magenta, Yellow, and blacK (CMYK)). Marking materials may be inks, paints, resins or other materials suitable for printing. The set of marking materials installed in the printer are also known as process colors.

In a further embodiment, printer 160 is a multi-pass printer (e.g., dual pass, 3 pass, 4 pass, etc.) wherein multiple sets of pel forming elements 165 print the same region of the print image on the print medium 180. The set of pel forming elements 165 may be located on the same physical structure (e.g., an array of nozzles on an ink jet print head 162) or separate physical structures. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, PDF and/or any other printer language data. The printer controller 140 processes the sheet image to generate a bitmap 150 for transmission. The bitmap 150 includes the instructions (e.g., instructed ink drop size and/or instructed pel forming element location) for the one or more printheads 162 and pel forming elements 165. Bitmap 150 may be a halftoned bitmap for printing to the print medium 180. The printing system 130 may be a high-speed printer operable to print relatively high volumes (e.g., greater than 100 pages per minute).

The print medium 180 may be continuous form paper, cut sheet paper, and/or any other tangible medium suitable for printing. The printing system 130, in one generalized form, includes the printer 160 that presents the bitmap 150 onto the print medium 180 (e.g., via toner, ink, etc.) based on the sheet image 120. Although shown as a component of printing system 130, other embodiments may feature printer 160 as an independent device communicably coupled to printer controller 140.

The printer controller 140 may be any system, device, software, circuitry and/or other suitable component operable to transform the sheet image 120 for generating the bitmap 150 in accordance with printing onto the print medium 180. In this regard, the printer controller 140 may include processing and data storage capabilities.

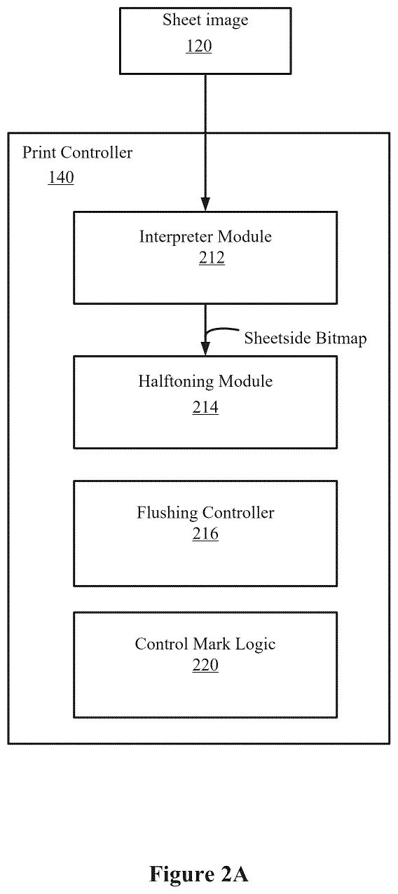

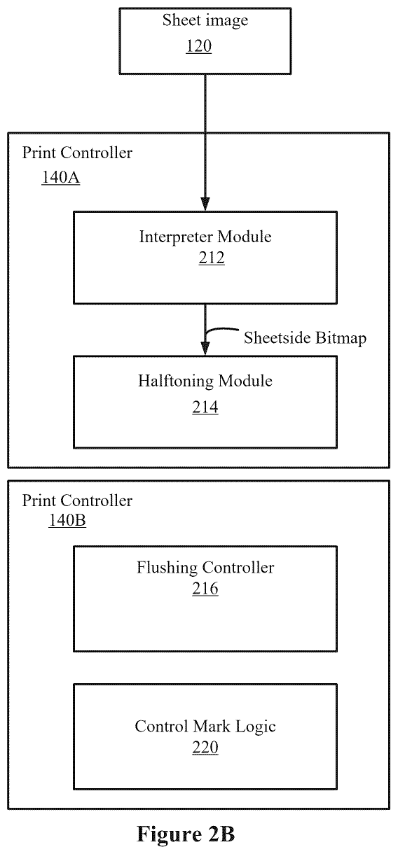

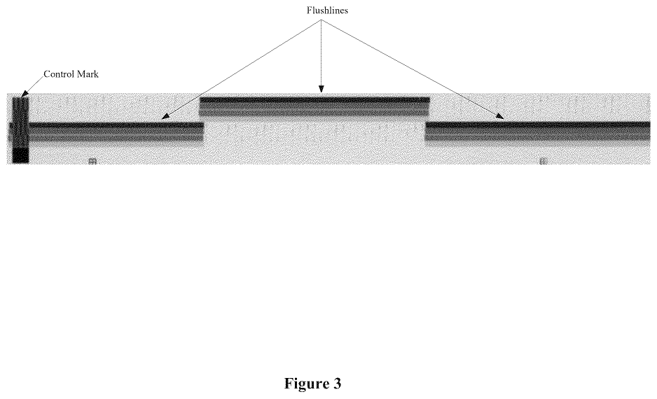

FIGS. 2A&2B are block diagrams illustrating embodiments of a printer controller 140. As shown in FIG. 2A, printer controller 140 (e.g., DFE or digital front end), in its generalized form, includes interpreter module 212, halftoning module 214, flushing controller 216 and control mark logic 220. These separate components may represent hardware used to implement the printer controller 140. Alternatively, or additionally, the separate components may represent logical blocks implemented by executing software instructions in a processor of the printer controller 140.

FIG. 2B illustrates an alternative embodiment having print controllers 140A& 140B. In this embodiment, printer controller 140A includes interpreter module 212 and halftoning module 214, while printer controller 140B includes flushing controller 216 and control mark logic 220. Print controllers 140A and 140B may be implemented in the same printing system 130 (as shown) or may be implemented separately.

Interpreter module 212 is operable to interpret, render, rasterize, or otherwise convert print instructions (e.g., raw sheetside images such as one or more sheet image 120) of a print job into sheetside bitmaps targeted for each print engine of printer 160. The sheetside bitmaps generated by interpreter module 212 are each a 2-dimensional array of pixels representing an image of the print job (e.g., a Continuous Tone Image (CTI)), also referred to as full sheetside bitmaps. The 2-dimensional pixel arrays are considered “full” sheetside bitmaps because the bitmaps include the set of pixels for the image. In one embodiment, interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel gray levels to output drop sizes based on pixel location.

Flushing controller 216 generates flushing pels for print jobs to prevent ink from clogging in pel forming elements 165 at printer 160 to ensure high print quality. As mentioned above, a color control mark that eliminates a line flushing mark may result in failure to flush all printing nozzles for all ink colors within the mark. For example, FIG. 3 shows a control mark and flushline configuration. In that configuration, an applied conventional control mark overrides the flushlines, resulting in the elimination of the flushlines in the area covered by the control mark. The conventional control mark (e.g., non-composite control mark) may comprise a printed single ink color (e.g., process black) using printing waveforms.

According to one embodiment, control mark logic 220 is implemented to generate a multi-color control mark to cue printing of a second sheet side, as well as facilitate line flushing. In such an embodiment, control mark logic 220 generates control mark print instructions to direct a print engine to print a control mark on a print medium and inserts printed control marks into instructed sheets of a print job based on the control mark print instructions, wherein a control mark comprises a matrix of print regions extending in process and cross-process directions having a plurality of ink colors.

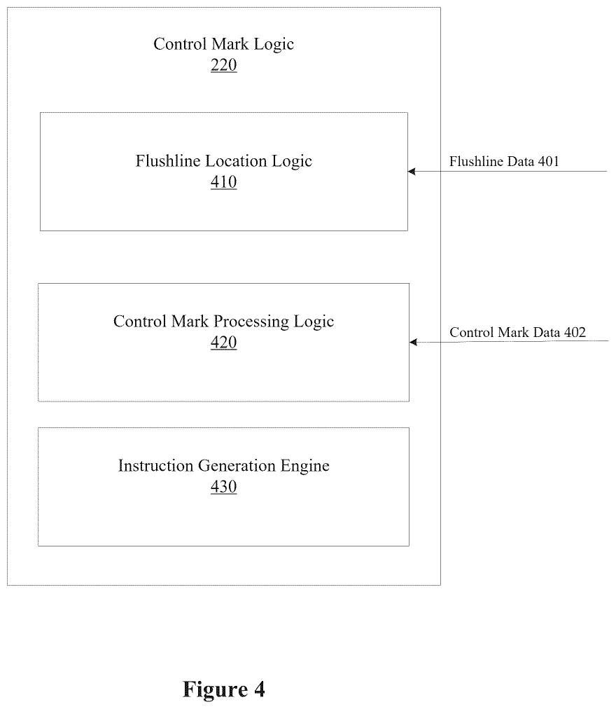

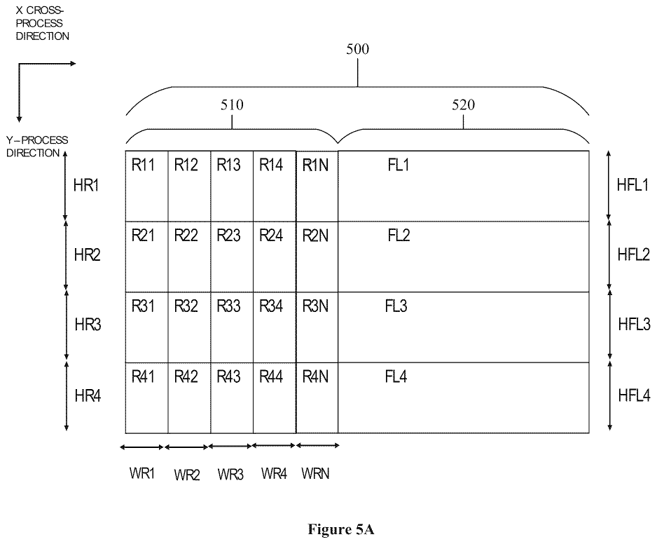

FIG. 4 illustrates one embodiment of control mark logic 220. As shown in FIG. 4, control mark logic 220 includes flushline location logic 410, control mark processing logic 420 and instruction generation engine 430. Flushline location logic 410 receives flushline data 401 from flushing controller 216 that indicates a location of a flushline pattern (or flushline area) on a print medium sheet, as well as a height of flushlines in a flushline pattern. As used herein, height refers to a length in the process direction. According to one embodiment, flushline location logic 410 determines the location of the flushline area on a sheet side based on the received flushline data 401. As mentioned above, the flushline pattern area may be specified to be located at the top or bottom portion of a sheet side.

Control mark processing logic 420 determines a location of a control mark to be printed in relation to a location of the flushline area based on the flushline area location determined by flushline location logic 410 and the received control mark data 402, which may include any combination of control mark size clear region sizes, control mark image data and/or control mark height specification. In one embodiment, control mark processing logic 420 also selects a control mark type that is to be printed based on the location of the flushline area (e.g., top or bottom portion of sheet side A). In such an embodiment, control mark processing logic 420 selects a non-composite control mark (e.g., a conventional control mark formed by a single ink color similar to the control mark in FIG. 3) as identified or received in control mark data 402 to be printed upon a determination that a flushline area is to be located on a different portion of sheet side A than the location of the control mark. The print instructions for the non-composite control mark specify a single ink color (e.g., black) and printing using print data waveforms since in this case it does not need to perform the flushing function.

In a further embodiment, control mark processing logic 420 selects composite control mark images received in control mark data 402 to be printed upon a determination that a flushline area is to be located on the same portion of sheet side A (e.g., printed over a flushline) as the location of the control mark. In this embodiment, the composite control mark (e.g., multi-color control mark) comprises a matrix of print regions extending in process and cross-process directions and having a plurality of ink colors. In a further embodiment, the control mark matrix comprises the composite control mark images. In such an embodiment, each composite control mark image begins with a different ink color and cyclically repeats all of the process colors, including black (e.g., alternates colors from one region to another). A printed composite control mark comprising alternating regions of each of the process colors (e.g., CMYK) produces a printed mark with overall dark color (e.g., a composite black) with corresponding high optical density as observed by the control mark sensor due to the process ink colors and an optical color mixing effect. The widths of the regions WRx may be made as small as needed to produce a composite black color that matches the optical requirements of the control mark sensor (e.g., sensor resolution, aperture opening dimensions, optical density thresholds, etc.) to detect an optical density change when the printed control mark passes the control mark sensor.

A technical benefit of the composite control mark is that it performs proper flushing in the control mark area because it contains all of the process colors. A technical benefit of setting the region Rxx heights to a plurality of dots (e.g., equal to the height of each flushline) includes improved flushing in the control mark area due to the flushing repetition. A further technical benefit of the composite control mark is that it is compatible with the control mark sensor as a printed control mark with suitable optical density. Yet another technical benefit is that by placing the composite control mark in the same portion of the sheet as the flushline pattern, wasted paper is avoided. Another technical benefit of the composite control mark is reduced ink drying issues in the control mark area since the ink coverage may be limited to one hundred percent unlike conventional control marks mentioned above.

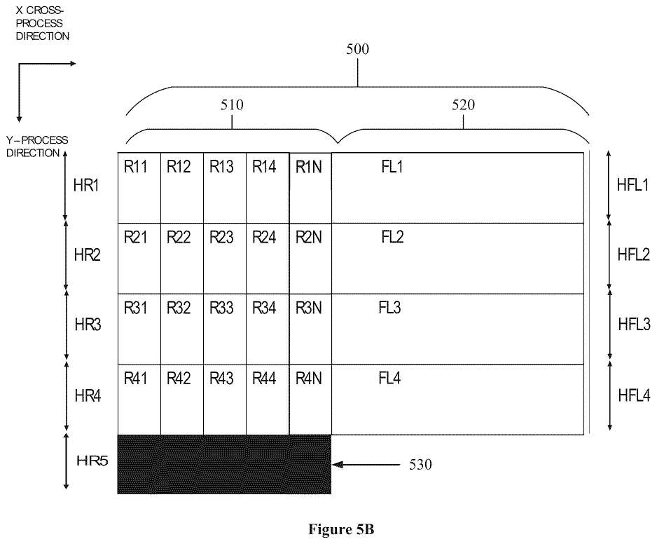

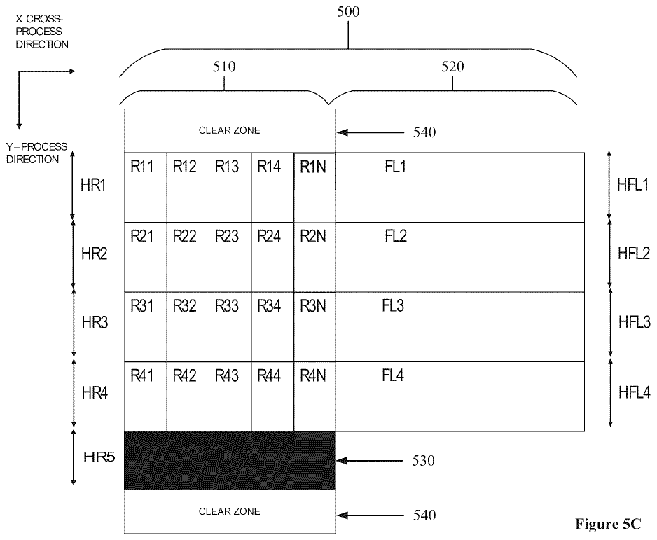

FIG. 5A illustrates one embodiment of a control mark and flushline configuration. As shown in FIG. 5A, a flushing area 500 includes a control mark 510 positioned adjacent to flushlines 520. In one embodiment, control mark 510 includes a matrix of print regions (e.g., R11-R4N) that may be implemented to perform flushing of pel forming elements 165. In such an embodiment, control mark 510 comprises ink applied with even density from each pel forming element 165 located in the cross-process direction width for each color plane to flush pel forming elements 165 corresponding to the regions.

In a further embodiment, the instructed ink colors of each edge adjacent regions comprise a different color. For example, regions R13, R24, R33 and R22 are edge adjacent to region R23, while regions R14, R34, R32 and R12 are not edge adjacent to region R23. Thus, the ink colors in region R13, R24, R33 and R22 are different than the ink color in region R23. A resulting technical benefit from alternating colors in the regions based on edge adjacency is improved computational efficiency to achieve that.

When used for flushing, the control mark 510 matrix regions Rxx have a height equal to the height of each flush line (e.g., HR1−HR4=HFL1−HFLN in flushlines 520). In that case, the control mark 510 height (e.g., HR1+HR2+HR3+HR4) is substantially equal to the flushlines 520 height (e.g., HFL1+HFL2+HFL3+HFL4). Thus, control mark processing logic 420 may also determine a height of the control mark 510 to match the flushlines 520 height based on the received flushline data 401.

According to another embodiment, control mark processing logic 420 may determine a control mark 510 height based on the control mark data 402 and set the control mark height to match the control mark 510 height specification. In a further embodiment, control mark processing logic 420 may also perform a lengthening operation on control mark 510 upon determining that the control mark 510 height specification is greater than the flushlines 520 height (e.g., control mark 510 height specification >HFL1+HFL2+HFL3+HFL4). In such an embodiment, the lengthening operation is performed to set the height of the control mark 510 matrix to be equivalent to the height of flushlines 520 in the process direction. Control mark processing logic 420 also inserts the control mark 510 matrix within flushline area contiguous to the flushlines 520 such that control mark 510 does not overlap flushlines 520.

In a further embodiment, control mark processing logic 420 also generates an extension mark upon determining that the control mark 510 height specification is greater than the flushlines 520 height. FIG. 5B illustrates an embodiment of the control mark and flushline configuration including an extension mark 530. As shown in FIG. 5B, the extension mark 530 is printed below the control mark 510 matrix to enable control mark 510 to conform to the control mark height specification. Thus, extension mark 530 comprises a height that when added to control mark 510 height equals the control mark height specification (e.g., extension mark 530 height+control mark 510 height=control mark height specification). Since extension mark 530 is not needed for flushing, it may comprise any combinations of color inks that produce proper optical density to trigger the control mark sensor (e.g., black ink or combinations of process color ink).

In yet a further embodiment, control mark processing logic 420 generates clear zones that are to be inserted above and below control mark 510 based on clear region sizes indicated in control mark data 402. FIG. 5C illustrates an embodiment of the control mark and flushline configuration including clear zones 540 placed above control mark 510 and below extension mark 530.

Instruction generation engine 430 generates control mark print instructions that direct a printhead 162 to print control mark 510 and flushlines 520 on print medium 180 as shown in either FIG. 5A, FIG. 5B or FIG. 5C. In one embodiment, the control mark print instructions specify that the ink colors are to be ejected in each of the control mark print regions Rxx according to the composite control mark images (e.g., different ink colors in each adjacent print region). In another embodiment, the control mark print instructions further specify that the ink colors in each of the control mark region Rxx be produced with flushing waveforms to further optimize the nozzle flushing in the regions. Instruction generation engine 430 also may transmit the print instructions to interpreter 212 to be included in a bitmap image sheet.

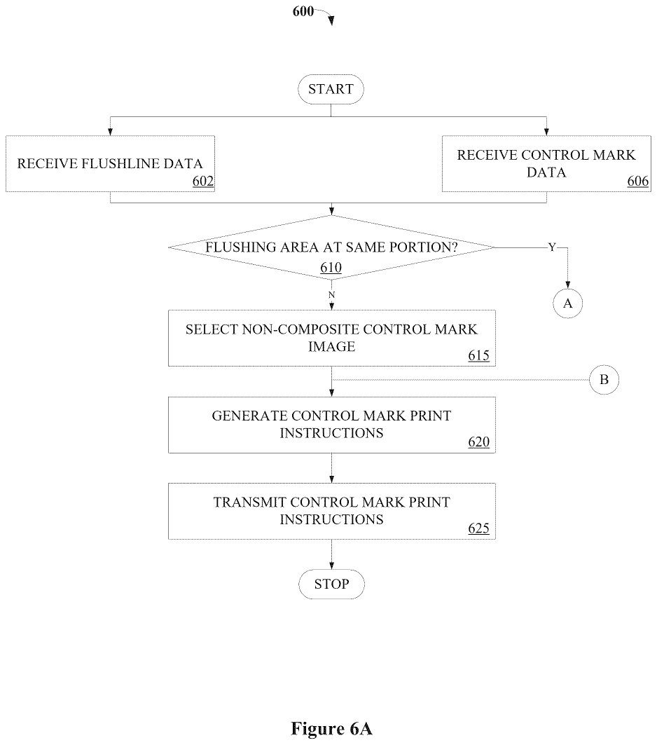

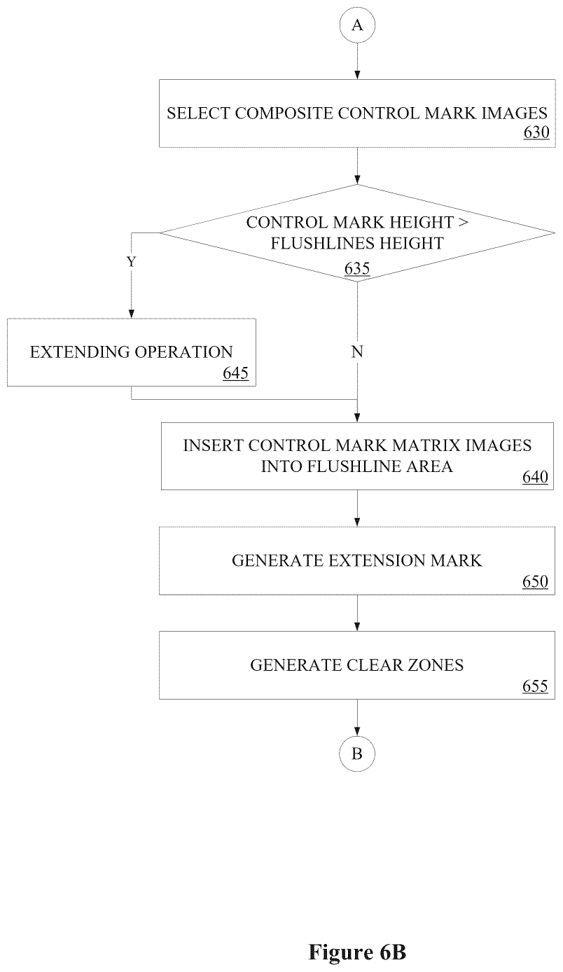

FIGS. 6A &6B is a flow diagram illustrating a process 600 for generating control mark print instructions. Process 600 may be performed by processing logic that may include hardware (e.g., circuitry, dedicated logic, programmable logic, microcode, etc.), software such as instructions run on a processing device, or a combination thereof. In one embodiment, process 600 is performed by control mark processing logic 420.

Process 600 begins at processing blocks 602 and 606, where flushline data 401 and control mark data 402, respectively, are received. At decision block 610, a determination is made as to whether the flushing area is located on the same portion of the sheetside as the control mark location. If not, a non-composite control mark image is selected from control mark data 402, processing block 615. At processing block 620, control mark print instructions are generated including the non-composite control mark image. At processing block 625, the control mark print instructions are transmitted (e.g., to interpreter 212 for printing by a first print engine).

Composite control mark images for the control mark matrix are selected from control mark data 402, at processing block 630, upon a determination at decision block 610 that the flushing area is located on the same portion of the sheetside as the control mark location (FIG. 6B). At decision block 635, a determination is made as to whether the control mark matrix height specification is greater than the height of the flushlines. If not, the composite control mark images are inserted as the control mark matrix into the flushline area, processing block 640. Otherwise, an extending operation is performed on the control mark matrix image, processing block 645, prior to inserting the control mark matrix image. At processing block 650, an extension mark 530 is generated. At processing block 655, the clear zones may be generated as specified in control mark data 402. Subsequently, control is returned to processing blocks 620 and 650 where control mark print instructions are generated (including instructions for the control mark matrix 519, the extension mark 530 and the clear zones 540) and transmitted (e.g., to interpreter 212 for printing by a first print engine).

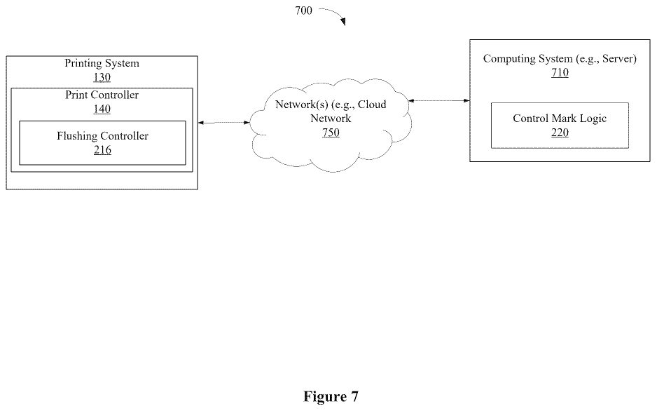

Although shown as a component of printer controller 140, other embodiments may feature control mark logic 220 included within an independent device, or combination of devices, communicably coupled to printer controller 140. For instance, FIG. 7 illustrates one embodiment of a control mark logic 220 implemented in a network 700.

As shown in FIG. 7, control mark logic 220 is included within a computing system 710 and flushing controller 216 is included within printer controller 140 at printing system 130. In this embodiment, printer controller 140 may receive control mark print instructions from control mark logic 220 via cloud network 750.

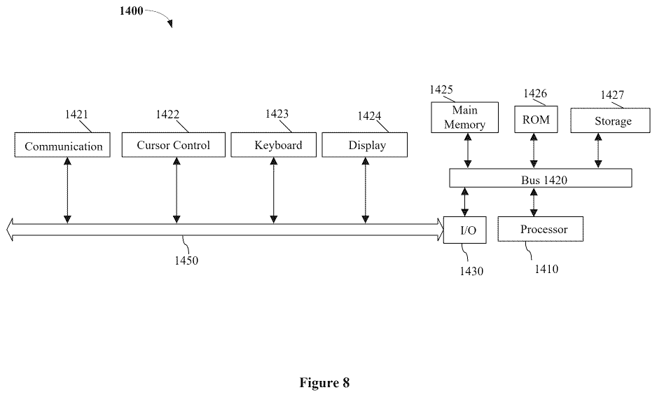

FIG. 8 illustrates a computer system 1400 on which printing system 130, printer controller 140, and/or control mark logic 220 may be implemented. Computer system 1400 includes a system bus 1420 for communicating information, and a processor 1410 coupled to bus 1420 for processing information.

Computer system 1400 further comprises a random access memory (RAM) or other dynamic storage device 1425 (referred to herein as main memory), coupled to bus 1420 for storing information and instructions to be executed by processor 1410. Main memory 1425 also may be used for storing temporary variables or other intermediate information during execution of instructions by processor 1410. Computer system 1400 also may include a read only memory (ROM) and or other static storage device 1426 coupled to bus 1420 for storing static information and instructions used by processor 1410.

A data storage device 1427 such as a magnetic disk or optical disc and its corresponding drive may also be coupled to computer system 1400 for storing information and instructions. Computer system 1400 can also be coupled to a second I/O bus 1450 via an I/O interface 1430. A plurality of I/O devices may be coupled to I/O bus 1450, including a display device 1424, an input device (e.g., an alphanumeric input device 1423 and or a cursor control device 1422). The communication device 1421 is for accessing other computers (servers or clients). The communication device 1421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising
at least one physical memory device to store control mark logic; and
one or more processors coupled with the at least one physical memory device to execute the control mark logic to:
generate control mark print instructions to direct a print engine to print a control mark on a print medium, wherein the control mark comprises a matrix of print regions extending in process and cross-process directions having a plurality of ink colors; and
insert printed control marks into instructed sheets of a print job based on the control mark print instructions.

2. The system of claim 1, wherein the control mark print instructions indicate an ink color to be included in each of the print regions.

3. The system of claim 2, wherein the control mark print instructions specify that the ink colors to be ejected in each of the print regions are different than the ink colors in each edge adjacent print region.

4. The system of claim 2, wherein generating the control mark print instructions comprises receiving control mark data and flushline data and determining a location of the control mark to be printed in relation to a location of a flushline area on a sheet of the print medium.

5. The system of claim 4, wherein generating the control mark print instructions further comprises determining that the flushline area is to be printed in a first location of the sheet and generating first control mark print instructions indicating that the control mark is to include the matrix of print regions to be printed in the flushline area.

6. The system of claim 5, wherein generating the control mark print instructions further comprises determining a control mark height specification based on the control mark data and setting the control mark height to match the control mark height specification.

7. The system of claim 5, wherein generating the control mark print instructions further comprises setting the height of the control mark to match the height of the flushline area.

8. The system of claim 7, wherein generating the control mark print instructions further comprises generating second print instructions indicating an extension mark to be printed on the sheet below the control mark, wherein a height of the control mark and the extension mark matches the control mark height specification upon determining that the control mark height specification is greater than a height of the flushline area.

9. The system of claim 5, wherein generating the control mark print instructions further comprises generating third print instructions indicating clear zones to be inserted above and below the control mark on the sheet.

10. The system of claim 5, wherein generating the control mark print instructions further comprises determining that the flushline area is to be printed in a second location of the sheet and generating second control mark print instructions indicating that the control mark is to include a single ink color to be printed on the sheet.

11. The system of claim 1, wherein the control mark is comprised of ink from each pel forming element located in the cross-process direction width for each of the plurality of ink colors.

12. The system of claim 1, further comprising a print engine including the print engine to print the control mark on the print medium.

13. At least one computer readable medium having instructions stored thereon, which when executed by one or more processors, cause the processors to:
generate control mark print instructions to direct a print engine to print a control mark on a print medium, wherein the control mark comprises a matrix of print regions extending in process and cross-process directions having a plurality of ink colors; and
insert printed control marks into instructed sheets of a print job based on the control mark print instructions.

14. The computer readable medium of claim 13, wherein the control mark print instructions specify ink colors to be ejected in each of the print regions are different than the ink colors in each edge adjacent print region.

15. The computer readable medium of claim 14, wherein generating the control mark print instructions comprises:
receiving control mark data and flushline data; and
determining a location of the control mark to be printed in relation to a location of a flushline area on a sheet of the print medium.

16. The computer readable medium of claim 15, wherein generating the control mark print instructions further comprises:
determining that the flushline area is to be printed in a first location of the sheet; and
generating first control mark print instructions indicating that the control mark is to include the matrix of print regions to be printed in the flushline area.

17. A method comprising:
generating control mark print instructions to direct a print engine to print a control mark on a print medium, wherein the control mark comprises a matrix of print regions extending in process and cross-process directions having a plurality of ink colors; and
inserting printed control marks into instructed sheets of a print job based on the control mark print instructions.

18. The method of claim 17, wherein the control mark print instructions specify ink colors to be ejected in each of the print regions are different than the ink colors in each edge adjacent print region.

19. The method of claim 18, wherein generating the control mark print instructions comprises:
receiving control mark data and flushline data; and
determining a location of the control mark to be printed in relation to a location of a flushline area on a sheet of the print medium.

20. The method of claim 19, wherein generating the control mark print instructions further comprises:
determining that the flushline area is to be printed in a first location of the sheet; and
generating first control mark print instructions indicating that the control mark is to include the matrix of print regions to be printed in the flushline area.
